(19) United States
(12) Patent Application Publication
(10) Pub. No.: US 2025/0065596 A1
(43) Pub. Date: Feb. 27, 2025

(54) REINFORCED-ELASTOMER ARTICLE WITH MICROPOROUS POLYMERIC FILM

(71) Applicant: GATES CORPORATION, Denver, CO (US)

(72) Inventors: BOBBIE E. SOUTH, Columbia, MO (US); Karla J. Bier, Columbia, MO (US)

(21) Appl. No.: 18/724,516

(22) PCT Filed: Dec. 20, 2022
(86) PCT No.: PCT/US2022/053548

§ 371 Date: Jun. 26, 2024

Related U.S. Application Data
(60) Provisional application No. 63/294,290, filed on Dec. 28, 2021.

(51) Int. Cl. B32B 5/18; B32B 1/08; B32B 3/30; B32B 5/02; B32B 5/24; F16G 1/28; F16G 5/06; F16G 5/20; F16L 11/08

(52) U.S. Cl. CPC B32B 5/18; B32B 1/08; B32B 3/30; B32B 5/02; B32B 5/245; F16G 1/28; F16G 5/06; F16G 5/20; F16L 11/08; B32B 2264/1021; B32B 2266/025; B32B 2413/00; B32B 2597/00

(57) ABSTRACT

A reinforced elastomeric article with a film layer having a microporous matrix of ultra-high-molecular-weight polyolefin compounded with a siliceous filler. The article may be a belt, hose, tire or the like. The film layer may reside on a contact surface or other surface of the article or may be embedded within the elastomeric article.

### BACKGROUND OF THE INVENTION

This invention relates generally to a reinforced-elastomer article such as a belt or a hose having a porous, polymeric film therein or on a surface thereof, more particularly having a microporous, ultra-high-molecular-weight, polyolefin film therein or thereon.

Reinforced-elastomer articles used in dynamic applications include belts, hose, tires, air-springs, wheels, anti-vibration components, and the like. Reinforcements used include short fibers, wires, cables, and various kinds of textiles, including cords and fabrics. The contact surfaces of such products may be rubber, textiles, or films. Elastomers include rubbers which are cured or vulcanized such as nitriles, ethylene-alpha-olefins, diene rubbers, acrylic rubbers, and the like; thermoplastic elastomers; cast elastomers such as cast polyurethanes and silicones; and the like.

Belts include power transmission belts and transport belts. Power transmission belts (or drive belts) are widely used to transmit torque between drive pulleys in a power transmission drive. Frictional drive belts include V-belts, flat belts, round belts, and other belt shapes, as well as multi-V-ribbed belts. Positive drive belts or synchronous belts include toothed power transmission belts with various tooth profiles. Toothed belts are also used to synchronize motion, i.e., as timing belts. Transport belts are widely used to move or transport materials, and may be flat or profiled, including with teeth for positive drive.

Hoses include fluid power or hydraulic hoses and fluid transport hoses. Impermeable polymer films are used as barrier layers in some hoses, as tubes, or as cover layers on hoses. Other reinforcements or covers used in or on hoses include wires, cables, cords, and fabrics.

Likewise, tires and other reinforced elastomer articles use various forms of textiles, fabrics, and cords for internal reinforcement or for surface covers.

Woven and knit fabric materials, in particular, have been used on belt and hose surfaces and within belts, tires, and hoses, as well as to reinforce other rubber articles. Non-woven fabric materials comprising random or partially oriented fibers have also been used on belt surfaces. Similarly, paper materials comprising random or partially oriented fibers have been used on belt surfaces.

Non-woven fabrics, woven fabrics, and paper-like materials may have a measurable porosity in the sense that they easily pass air. They may also pass rubber or other flowable materials under pressure. When non-woven fabrics, papers, or woven fabrics are used as a surface layer, for example on a belt, a degree of elastomer penetrating to the surface may be advantageous, or may be detrimental, depending on the desired surface characteristics. Control of elastomer penetration (also known as “strike-through”) may be very difficult, resulting in non-uniform surface characteristics. Non-wovens and papers are also prone to tearing when strained, resulting in further difficulties in producing a uniform surface characteristic. These uses and problems are described, for example, in U.S. Pat. No. 8,197,372 B2. Fabrics may therefore be pre-treated with rubber compositions or laminated with polymer films in order to better control surface characteristics. Such treatments add extra material and labor cost to the manufacturing process and to the resulting article.

Solid or dense, non-porous, polymer films have been proposed for use on belt surfaces. Such uses are described, for example, on toothed belts, in U.S. Pat. Nos. 6,296,588 B1, 7,011,880 B2, and 7,235,028 B2.

Micro-porous polymer films are known for use as print media, i.e., as synthetic paper. Such films are described, for example, in U.S. Pat. Nos. 3,351,495, 4,681,750, 4,866,172, 4,861644, and 4,877,679. It is not known or suggested to use a microporous, polymeric film as a reinforcement or cover material in or on a reinforced elastomer article such as a belt or hose.

### SUMMARY OF THE INVENTION

The present invention is directed to systems and methods which provide reinforced rubber articles with a highly filled, microporous, ultra-high-molecular-weight polymeric film therein or thereon, or with a microporous, ultra-high-molecular-weight polyolefin with siliceous filler as a film layer therein or thereon.

The inventive reinforced elastomeric article includes a layer of film having a microporous matrix of ultra-high-molecular-weight polyolefin compounded with a siliceous filler. The film layer may be characterized by a porosity in the range of 35% to 95% by volume. Preferred polyolefins are ultra-high-molecular-weight polyethylene, ultra-high-molecular-weight polypropylene, or a blend thereof.

The ultra-high-molecular-weight polyethylene may be essentially linear with a viscosity average molecular weight of at least 2,000,000; and the ultra-high-molecular-weight polypropylene may be essentially linear with a viscosity average molecular weight of at least 800,000.

The siliceous filler may be silica, which may be fumed, precipitated, or in other form. The siliceous filler may constitute from about 50 percent to about 90 percent by weight of the microporous film.

The inventive article may be a V-ribbed belt, a V-belt, a toothed belt, or other type of power transmission belt or a transport belt. The inventive article may be a hose, tire, airspring, or other reinforced elastomeric article.

The layer of film may be applied to a contact surface, such as the rib surfaces or a V-ribbed belt, the teeth of a toothed belt, or other external surfaces of a reinforced elastomeric article. The layer of film may be embedded within the body of the article. The layer of film may be laminated to a fabric, film or other material layer for the article. The layer of film may be used without coating or treatment, or it may be coated or treated for adhesion or for another reason.

The microporous ultra-high-molecular-weight polyolefin film is made by a process including the steps of mixing the ultra-high-molecular-weight polyolefin with the siliceous filler and an extractible diluent to make a mixture; forming a sheet from the mixture; and extracting the diluent from the sheet leaving a microporous matrix of polyolefin and filler.

The film may be printed on before assembling it into or onto the article. The film layer may be printed on after manufacturing the article if on an external surface.

A thin film of polyolefin, highly porous, highly permeable and filled with high levels of a siliceous filler, may be uniquely suited to adhesion with some elastomer materials, particularly ethylene-alpha-olefin elastomers and cast polyurethane elastomers. This film material lends itself to easy application and high-volume belt production. It can function as a natural wear indicator since it is white, and most elastomeric substrates are black. The microporous film can also be printed on for decorating, labeling, or other purpose in connection with an article.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a photomicrograph of a microporous, silica-filled, UHMWPE film at 10,000× useful in embodiments of the invention;

FIG. 2 is a partially fragmented perspective view of a V-ribbed belt embodiment of the invention;

FIG. 3 is a partially fragmented perspective view of a toothed belt embodiment of the invention;

FIG. 4 is a partially fragmented perspective view of a banded V-belt embodiment of the invention;

FIG. 5 is a partially fragmented perspective view of a hose embodiment of the invention;

FIG. 6 is a photomicrograph of a prior art paper-like belt surface material at 50×;

FIG. 7 is a photomicrograph of a prior art non-woven belt surface material at 200×;

FIG. 8 is a photomicrograph of a microporous, silica-filled, UHMWPE film at 5,000× useful in embodiments of the invention; and

FIG. 9 is a photograph of the cross section of a portion of a V-ribbed belt according to an embodiment of the invention.

### DETAILED DESCRIPTION

The present invention is directed to reinforced elastomer articles which incorporate therein or thereon a microporous polymeric film, wherein the film is characterized by a matrix of thermoplastic organic polymer, a very large proportion of finely divided particulate siliceous filler, and a high void content. The thermoplastic organic polymer may be essentially linear ultrahigh molecular weight polyolefin. The microporous, polymeric film used in the present invention may be further characterized by its material composition, its structure, and by methods of making it. Exemplary films and methods of making them are described in U.S. Pat. Nos. 3,351,495, 4,866,172, 4,861644, and 4,877,679, the contents of which are hereby incorporated herein by reference.

The composition of the film may include: (1) a matrix consisting essentially of essentially linear ultrahigh molecular weight polyolefin (“UHMW polyolefin”) which may be essentially linear ultrahigh molecular weight polyethylene (“UHMWPE”), essentially linear ultrahigh molecular weight polypropylene (“UHMWPP”), or a mixture thereof; (2) finely divided, particulate, substantially water-insoluble, siliceous filler distributed throughout the matrix, the filler constituting from about 50 percent to about 90 percent by weight of the microporous film; and (3) a network of interconnecting pores communicating throughout the microporous film, the pores constituting at least about 35 percent by volume of the microporous film.

The UHMWPE may have an intrinsic viscosity of at least about 18 deciliters/gram, or at least about 19 deciliters/gram, with no upper limit, or up to about 32 or 39 deciliters/gram. In other terms, the UHMWPE may have a nominal viscosity-average molecular weight of at least about 2,000,000, or at least about 3,000,000, with no upper limit, or up to about 6,200,000 or up to about 8,200,000.

The UHMWPP may have an intrinsic viscosity of at least about 6 deciliters/gram, or at least about 7 deciliters/gram, with no upper limit, or up to about 16 or 18 deciliters/gram. In other terms, the UHMWPP may have a nominal viscosity-average molecular weight of at least about 800,000, or at least about 1,000,000, with no upper limit or up to about 2,800,000 or up to about 3,300,000. The essentially linear UHMWPP may be essentially isotactic polypropylene. The degree of isotacticity of such polymer may be at least about 95 percent, and preferably it may be at least about 98 percent.

It is preferred that other thermoplastic organic polymers be substantially absent. Nevertheless, thermoplastic organic polymers which may optionally be present in the matrix are low density polyethylene, high density polyethylene, poly(tetrafluoroethylene), polypropylene, copolymers of ethylene and propylene, copolymers of ethylene and acrylic acid, and copolymers of ethylene and methacrylic acid. If desired, all or a portion of the carboxyl groups of carboxyl-containing copolymers may be neutralized with sodium, zinc or the like. At least about 70 percent UHMW polyolefin, based on the weight of the matrix, should provide the desired properties to the microporous film.

As present in the microporous film, the filler may be in the form of ultimate particles, aggregates of ultimate particles, or a combination of both. In most cases, at least about 90 percent by weight of the filler used in preparing the microporous film has gross particle sizes in the range of from about 5 to about 40 micrometers. Preferably at least about 90 percent by weight of the filler has gross particle sizes in the range of from about 10 to about 30 micrometers. The gross sizes of filler agglomerates may be reduced during processing of the ingredients to prepare the microporous film.

Examples of suitable siliceous fillers include silica, mica, montmorillonite, kaolinite, asbestos, talc, diatomaceous earth, vermiculite, natural and synthetic zeolites, cement, calcium silicate, aluminum silicate, magnesium silicate, sodium aluminum silicate, aluminum polysilicate, alumina silica gels, and glass particles. In addition to the siliceous fillers, other finely divided, particulate, substantially water-insoluble fillers may also be employed. Example of such optional fillers include carbon black, charcoal, graphite, titanium oxide, iron oxide, copper oxide, zinc oxide, antimony oxide, zirconia, magnesia, alumina, molybdenum disulfide, tungsten disulfide, zinc sulfide, barium sulfate, strontium sulfate, aluminum trihydrate, calcium carbonate, and magnesium carbonate. Silica and the clays are the preferred siliceous fillers. Of the silicas, precipitated silica, silica gel, or fumed silica is most often used. The particularly preferred finely divided, particulate, substantially water-insoluble, siliceous filler is precipitated silica.

In the case of the preferred filler, precipitated silica, the average ultimate particle size (irrespective of whether or not the ultimate particles are agglomerated) may be less than about 0.1 micrometer, or less than about 0.05 micrometer, or less than about 0.03 micrometer, as determined by transmission electron microscopy. The finely divided, particulate, substantially water insoluble, siliceous filler may constitute from about 50 to 90 percent by weight of the microporous film. Such filler may constitute from about 50 to about 85 percent by weight of the microporous material substrate. From about 60 percent to about 80 percent by weight is preferred.

Minor amounts, usually less than about 5 percent by weight, of other materials used in processing, such as lubricant, processing plasticizer, organic extraction liquid, surfactant, water, and the like, may optionally also be present. Yet other materials introduced for particular purposes may optionally be present in the microporous material substrate in small amounts, usually less than about 15 percent by weight. Examples of such materials include antioxidants, ultraviolet light absorbers, flame retardants, reinforcing fibers such as chopped glass fiber strand, dyes, pigments, and the like. The balance of the microporous film, exclusive of filler and any impregnant applied for one or more special purposes is essentially the thermoplastic organic polymer.

Pores constitute at least about 35 percent by volume of the microporous film. In many instances the pores constitute at least about 60 percent by volume of the microporous film. Often the pores constitute from at least about 35 percent to about 95 percent by volume of the microporous material. From about 60 percent to about 75 percent by volume is preferred.

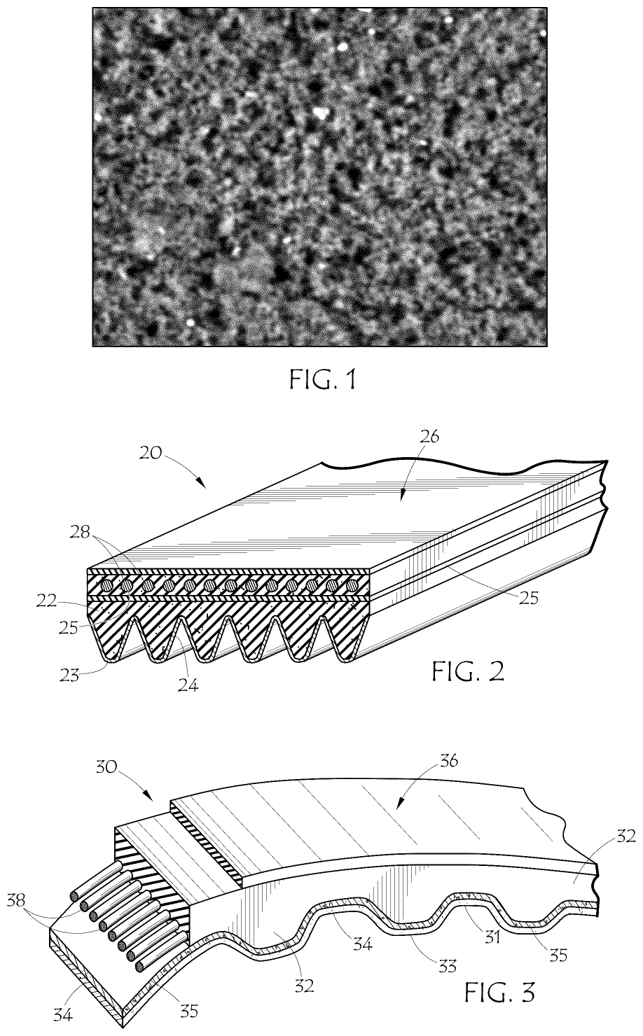

Macroscopically, the useful films appear like conventional paper, i.e., smooth, white sheets of predetermined thickness. Microscopically, the structure of the film is illustrated by FIG. 1, a greatly magnified scanning electron micrograph of an exemplary microporous UHMWPE material (Teslin® SP1400 at 10,000×). The microporous polymeric matrix, being only about 35% of the volume, appears as an interconnected network structure of thin filaments and walls, defining therein an interconnected network of pores or voids (the matrix structure and the pores being of similar dimensions).

The microporous film may be made by mixing filler, thermoplastic organic polymer powder, extractible diluent (which may advantageously be a processing plasticizer) and minor amounts of other ingredients such as lubricant and antioxidant until a substantially uniform mixture is obtained. The weight ratio of filler to polymer employed in forming the mixture is essentially the same as that of the microporous film to be produced. The uniform mixture may be sheeted out, for example, using an extruder with a sheeting die, heated rollers, calender, and/or the like. The sheet is then passed through one or more extraction zones where the extractible diluent or processing plasticizer is removed using a good solvent for the plasticizer that is a poor solvent for the matrix polymer and filler. Then the solvent is removed in a solvent extraction zone, typically using steam or water, followed by drying to substantially remove residual water and solvent. The residual processing plasticizer content may be less than 5 percent by weight of the microporous sheet substrate and this may be reduced even further by additional extractions.

At this stage, pores may constitute from about 35 to about 80 percent or from about 60 to about 75 percent by volume of the microporous film. The volume average diameter of the pores of the microporous may be in the range of from about 0.02 to about 0.5 micrometers, or from about 0.04 to about 0.3 micrometers, or from about 0.05 to about 0.25 micrometers. The sheeting process may induce anisotropic physical properties, specifically higher tensile strength in the machine direction and higher tear strength for tear propagation across the machine direction. The film produced by this process may be used advantageously in elastomeric articles according to embodiments of the invention.

However, the film may optionally be stretched, and the stretched microporous film may be used in embodiments of the invention. The stretching both increases the void volume of the material and induces regions of molecular orientation in the UHMW polyolefin. Physical properties of molecularly oriented thermoplastic organic polymer, including tensile strength, tensile modulus, Young's modulus, and others, may differ considerably from those of the corresponding thermoplastic organic polymer having little or no molecular orientation. The film may be stretched in one or more directions above the elastic limit. The stretch ratio may be at least about 1.5 or about 1.7, or in the range from about 1.5 to about 15, or from about 1.7 to 10, or from about 2 to 6. The stretching may be done at room temperature or at an elevated temperature. Optionally, biaxial stretching may be performed simultaneously or in multiple steps. Biaxial stretching may produce a more isotropic (less anisotropic) film, with higher tensile strength in all directions relative to the unstretched version.

The porosity of stretched microporous film may be greater than that of the unstretched film. Porosity may be more than 80 percent, or at least about 85%, or up to 95% by volume of the stretched microporous film. The volume average diameter of the pores of the stretched microporous material may be in the range of from 0.6 to about 50 micrometers or from about 1 to about 40 micrometers, or from about 2 to about 30 microns.

Various other steps, such as cooling, heating, sintering, annealing, reeling, unreeling, and the like, may optionally be included in the overall process as desired.

It is believed that the properties of the UHMW polyolefin, the regions of molecular orientation or anisotropy, the high levels of filler loading, the high degrees of micro-porosity cooperate to provide many of the desirable properties of the stretched microporous film when used in embodiments of the present invention.

Exemplary microporous films are sold under the trademark TESLIN by PPG Industries, Inc. Teslin® materials are marketed as printable, synthetic paper and are described as a microporous, dimensionally stable, highly filled, single-layer, polyolefin-based synthetic material. A non-abrasive inorganic filler comprises 60 percent of the weight, and it is 65 percent air by volume. It is believed that the polyolefin is essentially UHMWPE, and the filler is essentially silica, likely precipitated silica. The Teslin films are sheeted out so that the ratio of tensile strength in the machine direction to that in the cross direction is in the range of about 2 to about 3. Grades include various thicknesses, various strengths, uncoated and coated. Preferred grades for the present invention are the uncoated grades. For some applications, the higher strength, thicker grades are preferred. The thickness can be whatever is needed for a particular elastomeric article. For example, smaller belts could use thinner films and larger belts thicker films for a contact surface covering. It is believed that additional, optional stretching may not be present for most of the commercially offered Teslin materials. It is believed that this process may be used with other polymers besides polyolefins to make microporous polymeric films useful in embodiments of the inventive articles.

FIGS. 2-5 illustrate various embodiments of the invention utilizing microporous polymeric film in various ways.

FIG. 2 is a partially fragmented perspective view of a V-ribbed belt embodiment of the invention. In FIG. 2, ribbed belt 20 includes an elastomeric body 22 shaped into ribs 23 which are designed to frictionally engage mating grooves on a pulley or sheave. In embodiments of the invention, the microporous film described herein may be used on the rib surfaces as shown by rib cover 24 in FIG. 2. The microporous film may also be used as back cover 26 if desired. The microporous film may also be used as internal layer 25. Such layers may be used for reinforcement, for support for the tensile cord 28, or to tie other layers together. It is found that the microporous film of UHMW polyolefin has very good adhesion to conventional belt materials, especially to ethylene-alpha-olefin elastomer compounds which are widely used in belts. In many cases, the microporous film need not be treated with any adhesives or other coatings.

Any available or known process may be used for the manufacture of the V-ribbed belt. For the rib cover 24, some ribbed-belt molding processes require the cover to stretch over the ribs and/or around the belt. Prior cover materials, including non-woven fabrics and paper-like materials, often suffered from tearing and/or uneven stretching during such molding processes. The microporous film used in the invention has been found to stretch much more uniformly and without tearing during belt molding, compared to non-wovens and paper. FIG. 9 is a photograph of the cross section of a ribbed belt with microporous UHMWPE rib cover (Teslin® SP600) showing good uniformity of the surface layer after molding the belt. Moreover, the stretching during belt molding produces some similar beneficial effects as the optional stretching process described herein. Thus, it is believed that an unstretched microporous film becomes stretched to some extent during belt processing with a favorable increase in crystallinity, tensile strength, and tear strength. Likewise, a stretched microporous film may advantageously become even more stretched during processing. Methods of making V-ribbed belts are described for example in U.S. Pat. Nos. 6,824,485, 9,341,232 B2 and 9,341,233 B2.

Rib cover 24, a microporous film of UHMW polyolefin with high silica loading, also has excellent frictional properties and good wear resistance for use on ribbed belts. Solid UHMWPE film has been tried but has not been successful on ribbed belts because of its very low coefficient of friction (“COF”). Surprisingly, the microporous UHMWPE film with silica filler has a suitable COF for use on ribbed belts.

FIG. 3 is a partially fragmented perspective view of a toothed belt embodiment of the invention. In FIG. 3, toothed belt 30 has an elastomeric belt body 32 which may be of an elastomeric belt material such as rubber, cast polyurethane, or thermoplastic elastomer, with belt teeth 33 formed on one side of the body and alternating with lands 31, defining a predetermined pitch or spacing. The teeth may be covered with a microporous polymeric film 34 according to embodiments of the invention. Microporous film 34 may thus be disposed along peripheral surfaces of the belt teeth. A tensile member 38 of helically spiraled cord may be embedded in the belt body. The back of the belt may be smooth and located opposite the toothed side and may also optionally be covered with microporous film 36. Thus, one or both of the tooth cover and back cover may be microporous film, while one or the other may be conventional fabric or jacket or uncovered. Generally, “fabric” refers to the conventional cover material before adhesives or other suitable coatings are applied, and a treated fabric, ready for use in building a belt or in place on a belt is called “jacket.” Thus, the microporous film may replace conventional fabrics and jackets used in or on toothed belts. The microporous film provides better adhesion to the belt body than the solid thermoplastic films that have been tried in the past. Any available or known process may be used to manufacture the toothed belt.

The toothed belts of the invention may be manufactured according to known methods of making vulcanized elastomer or rubber belts, such as methods disclosed in U.S. Pat. Nos. 4,392,842, 4,586,915, 6,695,733. Exemplary methods of making toothed belts with polymeric films are disclosed in U.S. Pat. Nos. 6,296,588 B1, 7,011,880 B2, and 7,235,028 B2, the contents of which are hereby incorporated herein by reference. The most common approach is to apply the various materials to a grooved mandrel, beginning with the tooth cover jacket, i.e., the microporous polymeric film, then other materials, such as fabric, tensile cord, and body rubber, and ending with an optional back jacket, which may also be microporous film. The mandrel with the belt slab is then inserted into a pressurizable shell which can be heated and pressurized to squeeze the materials together, causing the rubber to flow into the teeth grooves pushing the tooth jacket into the shape of the grooves (the “flow-through” method). Alternately, the teeth can be preformed into the approximate groove shape, optionally with rubber filling the teeth, before placing the tooth jacket on the mandrel (the “preform method”). The film can be coated on one side for adhesion or both sides if desired. The film can be laminated to other materials such as fabric before or during molding. Cast polyurethane belts are built up in a similar way except the body rubber is introduced as a flowable liquid. Other variations on these methods are also possible.

While film 34 may be the only covering on the teeth, FIG. 3 also illustrates that microporous film 34 may be laminated or applied on another tooth cover material 35. The lamination may occur offline before belt building or during belt molding. The other cover material 35 may be any conventional or known fabric or jacket. In an exemplary embodiment, the microporous film is laminated to a nylon tooth fabric for use in cast polyurethane belts. By “cast” or castable is meant liquid processable elastomeric materials such as those formed by liquid casting, applicable to many forms of polyurethane (including polyurea and polyurea/urethane). The outer microporous film may serve to prevent liquid polyurethane materials from penetrating to the surface of the belt during casting. The microporous film may thus replace conventional thermoplastic films used on polyurethane belt surfaces to seal off the surface fabric from polyurethane strike through. For this use, the unstretched microporous film is preferred. Stretching greatly increases the pore size and increases the risk of strike through with liquid polymer casting. The microporous thermoplastic polymeric film can be preformed to the shape of the toothed belt surface to minimize stretching during belt molding. If desired, the microporous thermoplastic polymeric film can be laminated to a fabric or other film material before or during processing into the belt. The lamination and preforming steps can also be combined in a single operation or carried out sequentially. Examples of polyurethane belt manufacturing methods are found in U.S. Pat. Nos. 5,112,282, 5,907,014, and 6,964,626.

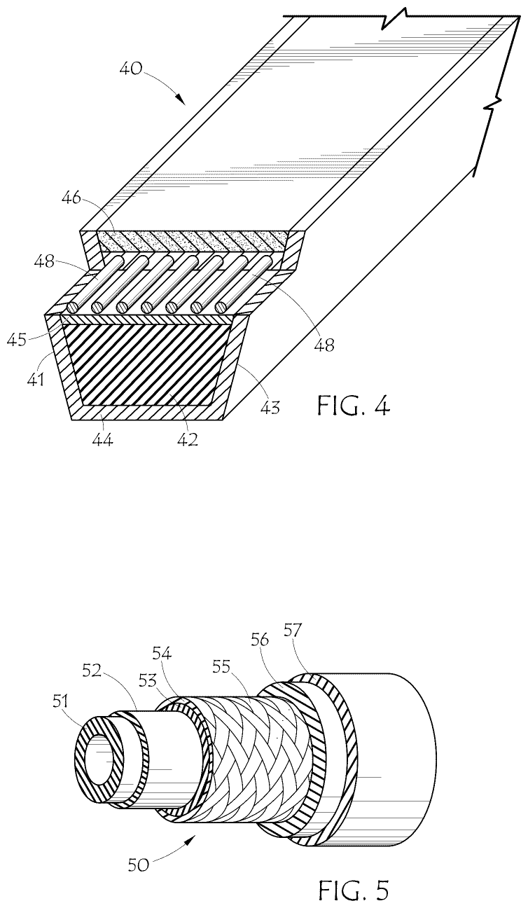

FIG. 4 is a partially fragmented perspective view of a banded V-belt embodiment of the invention. In FIG. 4, V-belt 40 includes belt body 42 with tensile cords 48 embedded therein. Bandply layer 44, which traverses and is bonded to the bottom surface and each of the angled side surfaces 41, 43 of belt body 42, may be formed of microporous polymer film according to embodiments of the invention. In other embodiments, one or more such bandply layers could completely surround the belt body, including the back surface 46, or cover the back surface 46 and extend down the angled sides 41, 43, or a belt could have a combination of such band plies. Conventional band plies are formed of a fabric, that is, a planar textile structure produced by interlacing yarns, fibers, or filaments, and are typically rubberized on at least the inner side facing the belt body, for adhesion thereto. The microporous films of UHMW polyolefin used in the invention make for an exterior surface that may be left bare, for example, for clutching applications, or also rubberized as desired. Good adhesion may be observed without rubberizing the inner side of the film, especially for ethylene-alpha-olefin elastomeric belt body compounds. The microporous film may also be used as an internal layer such as internal layer 45. Such layers may be used for reinforcement or for support for the cord, or to tie other layers together. Any available or known process may be used to manufacture the V-belt or banded V-belt utilizing the microporous film according to embodiments of the invention. For example, U.S. Pat. No. 11,028,900 B2 describes methods of making banded V-belts. Notched or cogged V-belts and methods are disclosed in U.S. Pat. Nos. 4,106,966 and 2,016,140. Other exemplary V-belts are disclosed in U.S. Pat. Nos. 3,941,005, 3,869,933, 4,231,826, and WO 2021/016495 A1.

FIG. 5 is a partially fragmented perspective view of a hose embodiment of the invention. In FIG. 5, hose 50 includes a number of layers shown in one possible configuration, but it should be understood that any number of duplicate layers may be added, or rearrangements made, or layers omitted, within the scope of the invention, as long as at least one layer is a microporous polymeric film, preferably of UHMW polyolefin with siliceous filler as described herein. The inner most layer 51 of hose 50 is called the tube or inner tube of the hose, which may be chosen in a conventional way for any desired property, such as resistance to the fluids to be used in the hose. Liner 52 is a layer immediately next to tube 51. Liner 52 may be advantageously formed of microporous polymeric film according to various embodiments of the invention. Elastomeric layers 53 and 56 may be selected according to conventional hose design, and may be referred to as skim layers, friction layers, tie layers, or other common terms in the art. Reinforcement 55 may be selected according to conventional hose design, for example, braided or spiraled yarns, wires, filaments, or cables, or the like. A so-called fabric breaker layer is often used, for example in spiral hoses between the tube and the 1st friction layer and wires, in order to provide support for wires and prevent them from cutting into the tube. Breaker layer 54 may be advantageously formed of microporous polymeric film according to various embodiments of the invention. Various tie layers are often used for improved adhesion between any other two material layers. Thus, in FIG. 5, liner 52 and breaker 54 may also be considered illustrative of tie layers which may be advantageously formed of microporous polymeric film according to various embodiments of the invention. Finally, abrasion layer 57 is the external layer or outermost layer of hose 50, and it may also be advantageously formed of microporous polymeric film according to various embodiments of the invention. As in belt applications, the microporous film provides excellent wear resistance, adhesion to rubber or other elastomeric layers in the hose. The microporous film could be applied to the hose by wrapping a suitable strip parallel to the length of the hose and overlapping or butt joining the edges, or by spiral wrapping a suitable strip with a suitable helix angle for overlapping or butt joining the edges. Any available or known process may be used to manufacture the hose. Exemplary manufacturing methods are described for example in U.S. Pat. Nos. 7,694,695 B2, 7,572,745 B2, and 10,036,491 B2.

In summary, microporous polymeric film may be used in reinforced elastomeric articles as a substitute for conventional textile reinforcement layers or for solid polymeric films. The microporous film may be used on an external surface of an elastomeric article or embedded within the article. The microporous film can be chosen to have good compatibility with the body of the elastomeric article, resulting in good bonding without the use of adhesive coatings. The microporous film may thus result in fewer manufacturing steps and reduced cost over traditional textile reinforcements. When used as an outer layer on an elastomeric article, such as a belt or hose, the microporous film offers the potential of unlimited printing or decorating of the article. The film may be printed on before applying to the article or after the article is formed. It may be printed with any design or picture desired for advertisement, information, or anti-tampering. It could be used as a label material on the back of the belt which would allow any kind of printing desired. Whereas most conventional belt and hose covers are coated and the same color as the belt body (usually black), the printability and/or natural whiteness of the microporous film offers the possible of a very high contrast between the film layer and the belt body. This contrast may be utilized as a wear indicator, for example using any one of the arrangements disclosed in U.S. Pat. No. 10,994,521 B2, namely one or more natural white or distinctly colored film layers applied to a wear surface of an article to provide progressive indication of the state of wear. In some embodiments, belts covered with the microporous film exhibit less or slower dusting or debris generation that may come from conventional belt cover materials from abrasive running conditions.

UHMW polyolefin films that are highly porous, highly permeable and filled with high levels of a white filler (such as silica) may be uniquely suited for adhesion with ethylene-alpha-olefin elastomers and compounds based on such elastomers. These films also have good wear resistance and COF properties, making them uniquely suited for use in and on elastomeric belts including V-belts, V-ribbed belts, and toothed belts, as well as other articles. Although untreated or uncoated polyolefin films may be preferred when their natural adhesion, COF and wear resistance are desirable, they may also be used in any of the articles mentioned herein after being treated on one or both sides, whether for improved adhesion, appearance, or other purpose. Such treatments that may be applied include skim or friction layers of rubber, laminations of other polymeric films, liquid adhesives such as rubber cements, resorcinol formaldehyde latex (“RFL”) treatments, and other latex-based treatments, as non-limiting examples.

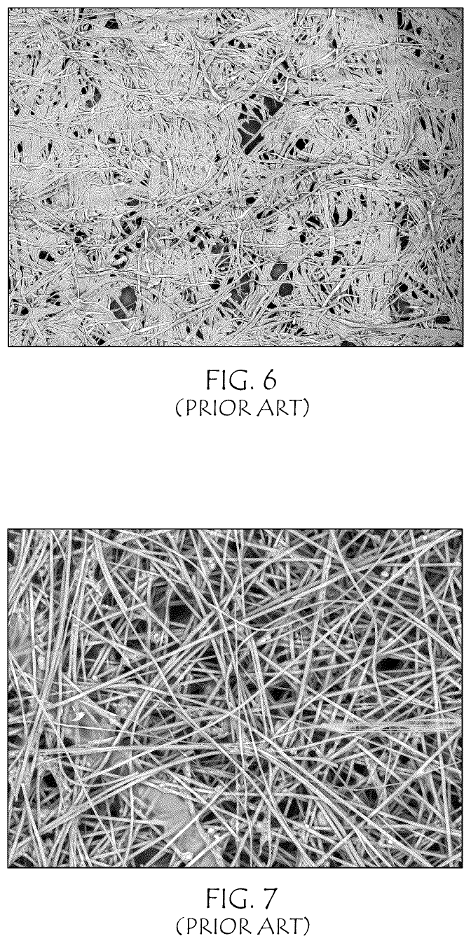

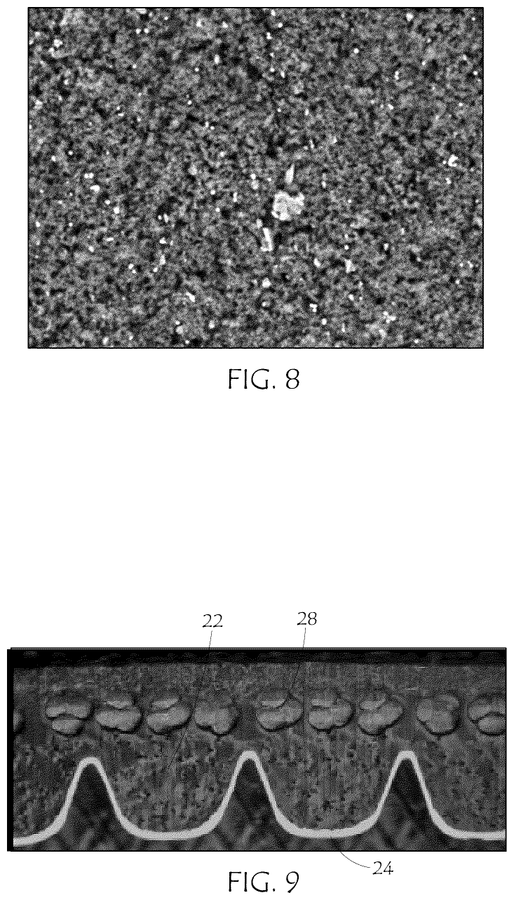

These films are structurally distinct from prior art “paper” materials and nonwoven materials that have been used on belts surfaces. FIG. 6 shows the surface of a prior art paper-like material made of cellulose fibers, magnified 50×. The paper is characterized by randomly oriented fibers creating rather large voids with a clear lack of uniformity. FIG. 7 shows the surface of a prior art non-woven material made of acrylic micro-fibers, magnified 200×. The nonwoven has better uniformity than the paper, but the voids are still quite large, relative to the thickness of the fibers. FIG. 8 shows the surface of a microporous UHMWPE film (Teslin® HD1400) magnified 5000×, and FIG. 1 shows the surface of a film of Teslin SP1400 magnified 10,000×. The structural difference from the prior art includes much smaller voids or finer porosity, much greater uniformity even at a much magnified scale, and a continuous matrix structure instead of a collection of fibers. The microporosity may be considered sub-micron in size.

### Examples

The first set of examples illustrate the wear resistance and adhesion of microporous UHMWPE films, as needed for use in reinforced elastomer composite articles according to the invention. The wear resistance was evaluated on the Taber abrader test (ASTM D-3389). The Taber test results are in terms of weight loss, so lower is better. Table 1 shows the results of the test. The comparative example, “Comp. Ex.” 1, was a conventional toothed belt jacket for use on cast polyurethane belts. The jacket consisted of a polyethylene surface film laminated onto a nylon fabric. Inventive example, “Ex.” 2, consisted of the same jacket material but with a microporous UHMWPE film laminated thereon. Teslin SP600 substrate from PPC Industries Inc. with a thickness of 0.148 mm was used. For Ex. 2, Teslin SP1400 substrate with a thickness of 0.356 mm was used over the jacket of Comp. Ex. 1. Table 1 indicates that the inventive examples had less than half the weight loss of the comparative example. This indicates very acceptable wear resistance for use in belts on wear surfaces.

Also in TABLE 1 are the adhesion results for two grades of Teslin substrate on two different cast polyurethane formulae. Relatively speaking, Teslin substrates have a rough side and a smooth side. Clearly, the rough side has better adhesion than the smooth side, which is believed to be an effect of a surface porosity difference between the two sides. Ex. 4, Teslin HD1400, has the same thickness as SP1400, but higher density, indicating less porosity. The SP1400 of Ex. 3 had better adhesion than the HD1400 of Ex. 4, indicating that the porosity (or rather microporosity) is very likely a major reason for the good adhesion observed. Cast polyurethane belts have been made with these Teslin materials as tooth covering, with adhesion and durability results that correlate well with the TABLE 1 results from simple lab tests. The belts have exhibited promising performance on a durability test.

TABLE 1

| | Comp. | | | |
|---|---|---|---|---|
| | Ex. 1 | Ex. 2 | Ex. 3 | Ex. 4 |
| Material(s) | PE/nylon | Teslin ® | Teslin ® | Teslin ® |
| | | SP600 | SP1400 | HD1400 |

Taber Weight Loss (g)

| | | | | |
|---|---|---|---|---|
| @ 1000 cycles (g)¹ | 0.032 | 0.012 | 0.007 | — |
| @ 5000 cycles (g)¹ | 0.103 | 0.050 | 0.043 | — |
| @ 10,000 cycles (g)¹ | 0.280 | 0.083 | 0.065 | — |

Adhesion to polyurethane²

| | | | | |
|---|---|---|---|---|
| Formula 1 on smooth | — | — | 18.7 | 11.8 |
| side | | | | |
| Formula 1 on rough side | — | — | 22.0 | 13.5 |
| Formula 2 on smooth | — | — | 18.4 | 17.1 |
| side | | | | |
| Formula 1 on rough side | — | — | 26.2 | 17.4 |

¹Average of two samples on two respective Taber wheels.
²Peak peel force (lb/in)

The second set of examples illustrate the use of a microporous UHMWPE film on the ribs of a V-ribbed belt. The test belts comprised tensile cords 28 embedded in rubber body 22, with microporous film 24 on a multi-v-ribbed profile as described generally in FIG. 2 and as photographed in cross section in FIG. 9. The belt in FIG. 9 used EPDM-based elastomeric materials, polyester tensile cord, and Teslin SP600 substrates as the microporous film. The belt was tested for wet and dry coefficient of friction (“COF”) and for misalignment noise (“MAN”) on a misalignment noise test, as described in U.S. Pat. No. 8,197,372 B2, the contents of which are hereby incorporated herein by reference. The results can be summarized.

New belts exhibited wet and dry COF of 0.54 and 1.59, respectively. After run-in, the COF settled down to wet and dry values of 1.08 and 1.14, respectively, which is almost ideal, because they are almost the same. Note that the belts used the thinnest grade of Teslin substrate available, and it met the belt performance targets. The Teslin material does wear off over time, so thicker grades would be expected to run longer. Some belt tests were successfully run at 121° C., which is close to the reported melting point of polyethylene. In such tests, the actual belt temperature may be as high as 130-135° C. due to hysteretic heating. Thus, microporous UHMWPE films are also useful in elevated temperature applications and are reported to be usable up to 180° C.

The MAN testing was carried out under three conditions: (1) 35° C. and 90% relative humidity (water mist); (2) −20° C. and 0% relative humidity; and (3) 5° C. and 0% relative humidity. The tests were repeated with new belts and with conditioned or worn in belts. All tests were passed successfully by the inventive test belts, meaning no audible noise was generated.

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

What is claimed is:

1. A reinforced elastomeric article comprising a layer of film comprising a microporous matrix of ultra-high-molecular-weight polyolefin compounded with a siliceous filler.

2. The article of claim 1 wherein the film layer is characterized by a porosity in the range of 35% to 95% by volume.

3. The article of claim 1 wherein the polyolefin is ultra-high-molecular-weight polyethylene, ultra-high-molecular-weight polypropylene, or a blend thereof.

4. The article of claim 2 wherein the ultra-high-molecular-weight polyethylene is essentially linear and has a viscosity average molecular weight of at least 2,000,000; and the ultra-high-molecular-weight polypropylene is essentially linear and has a viscosity average molecular weight of at least 800,000.

5. The article of claim 1 wherein the siliceous filler is silica.

6. The article of claim 1 wherein the siliceous filler constitutes from about 50 percent to about 90 percent by weight of the microporous film.

7. The article of claim 1 in the form of a V-ribbed belt.

8. The article of claim 7 wherein the layer of film is applied to the rib surfaces which are meant to contact mating sheaves.

9. The article of claim 7 wherein the film layer is applied to the backside of the V-ribbed belt or embedded within the belt.

10. The article of claim 1 in the form of a toothed belt.

11. The article of claim 10 wherein the film layer is applied to the toothed surface of the toothed belt which is meant to contact mating pulleys.

12. The article of claim 11 wherein the film layer is laminated to a fabric layer.

13. The article of claim 1 in the form of a hose.

14. The article of claim 13 wherein the film layer is the outermost layer of the hose.

15. The article of claim 13 wherein the film layer is embedded within the hose as a tie layer, a breaker layer, or a liner.

16. The article of claim 1 in the form of a V-belt wherein the film layer is embedded within the V-belt.

17. The article of claim 1 in the form of a banded V-belt wherein the film layer is a bandply layer on one or more outer surfaces of the banded V-belt.

18. The article of claim 1 wherein the film is made by a process comprising:
mixing the ultra-high-molecular-weight polyolefin with the siliceous filler and an extractible diluent to make a mixture;
forming a sheet from the mixture; and
extracting the diluent from the sheet leaving the microporous matrix of polyolefin and filler.

19. The article of claim 1 wherein the film is printed on before assembling it into or onto the article.

20. The article of claim 1 wherein the film is printed on after manufacturing the article.
